(19) United States
(12) Patent Application Publication
(10) Pub. No.: US 2021/0387533 A1
(43) Pub. Date: Dec. 16, 2021

(54) Dynamic Wireless Inductive Charge Transfer System

(71) Applicant: LCR Dynamics LLC, Crossville, TN (US)

(72) Inventors: Joseph A. Swift, Crossville, TN (US); Christian M Heislop, Crossville, TN (US)

(73) Assignee: LCR Dynamics LLC, Crossville, TN (US)

(21) Appl. No.: 17/235,595

(22) Filed: Apr. 20, 2021

Related U.S. Application Data
(60) Provisional application No. 63/013,250, filed on Apr. 21, 2020.
(60) Provisional application No. 63/020,629, filed on May 6, 2020.
(60) Provisional application No. 63/031,267, filed on May 28, 2020.

(51) Int. Cl. B60L 50/61; H02J 50/10; H02J 50/40; B60L 8/00

(52) U.S. Cl. CPC B60L 50/61; H02J 50/10; H02J 2310/48; B60L 8/003; H02J 50/40

(57) ABSTRACT

An energy transfer apparatus comprises at least one induction energy transmitting source, at least one induction energy receiving source, at least one energy control unit, and at least one electrical conductor; wherein at least one of the at least one induction transmitting source, the at least one induction energy receiving source, the at least one electrical conductor, and the at least one energy control unit comprise an integrated system that is operational while in a stationary state and while in motion.

### CROSS-REFERENCE TO RELATED APPLICATIONS

This application claims the benefit of U.S. Provisional Application No. 63/013,250 entitled “Dynamic Wireless Inductive Charge Transfer System” filed Apr. 21, 2020; U.S. Provisional Application No. 63/020,629 entitled “Dynamic energy Transfer System Employing and Active Airfoil and Method of Use” filed May 6, 2020; and U.S. Provisional Application No. 63/031,267 entitled “Electromagnetic Field Shaping Inductive Energy Transfer Apparatus” filed May 28, 2020; each of which is incorporated by reference in its entirety.

### BACKGROUND

This application generally relates to wireless power transfer for a variety of power consuming devices such as electric vehicles that are in motion.

There is a growing need for wireless power systems that supply dynamic power to an in-use device. The number of electric powered vehicles and other mobile devices that consume large as well as small power loads is increasing as is the need for real-time delivery of sufficient power to enable dynamic operation, motion, and mobility of said vehicle or device. Further, the use of mobile communications, security, and computing devices in commerce, entertainment, medicine, military, transportation, and business routinely employ continuous connections to data networks and thusly require reliable, dynamic power to sustain continuous operation over long periods of use and particularly beyond those relatively long, in-use periods which can be supported by conventional battery sources. To maintain this degree of non-stop use, connectivity, and mobility, there is an ever-increasing need for the devices to be continuously powered, especially when the device is, for example, a large electric vehicle that is in motion and therefore away from a conventional, stationary power source.

There has been a recent proliferation of induction pads and USB hubs that are available in fixed locations in airports, libraries, coffee shops and other establishments that successfully service the power needs of many personally portable devices. A wide variety of power-bars, power strips, and extension cords now have USB connectors for recharging smartphones via direct-wire methods, for example, and various other portable electronic computing devices. However, the limitations of present USB connected power stations are well known. Characteristically, we observe power limitations of these devices to fall in the range of about 5 watts (W) to about 15 watts (W) wherein the upper end of this range has been referred to as “medium power”. There has also been a proliferation of induction charging pads that are capable of wirelessly transferring power to smartphones and other devices, albeit under a constraint to stationary locations since the source of power to the pads is tethered by wire to a grid. It may be concluded, therefore, that power delivered by known, commercially available induction charging pads is not fully wireless. Collectively, all of these may be accurately described as stationary, low power delivery devices (SLPDDs).

Portable electric and electronic devices require a variety of electrical power connections, and the interconnecting rigid, semi-rigid, or wireless connections differ not only in power requirements, but also in hardware and connection characteristics depending on what country one is travelling in.

Special-use electric and electronic equipment is increasingly being developed for extreme, volatile, hazardous, or ultra-clean environments, where power is necessary but traditional electric power sources, including contemporary stationary power sources, including SLPDDs, are not viable.

High electric energy consuming vehicles, for example battery powered cars, also referred to as “electric cars” and “electric vehicles”, as well as electric trucks, are increasing in number. Such vehicles typically employ rechargeable batteries or other energy storage devices that provide the power required to sustain constant motion. The process of recharging these power storage units is slow and typically requires many hours. Most of the power transferred to recharge these storage units requires a wired interconnection between a high voltage and high amperage AC source and the vehicle. Most of these batteries are rigid-mounted, nearly permanently, within recesses of the vehicles and require wire tethering the vehicle directly to a grid supplied 220-240 volt, 50 amp AC (i.e. 11-12 KW) outlet. Electric car manufacturers are choosing to develop and deploy ever-increasing size and capacity batteries to provide for travel distances to meet minimum requirements of the driving public. As a result, batteries are getting to represent a considerable portion of the entire weight of the vehicle. It is a way of life today where the operator of a vehicle wishing to travel long distances must plan for multiple recharging stops to provide sufficient power to recharge the batteries to continue on the trip. Included in the planned stops must be extended periods of what may be viewed as lost travel time to allow for the times required for multiple recharging operations. Emerging is a network of higher energy charging stations along roads and highways and at various public places that are capable of delivering up to about 20 KW and are referred to as “Super Chargers”. The power required to supply these charging stations is also grid tied and the vehicle needs to be connected by wire to the charging station in order to enable charge delivery to the vehicle. Obviously, a vehicle so tethered to any fixed power source cannot simultaneously be in a state of motion. Today, we are witnessing various configurations of wired and wireless, high energy delivery devices that are emerging to support the charging requirements of those vehicles. These delivery devices are limited in that they all are functional while they are fixed in location, or stationary, and thusly may be described as Stationary, High Power Delivery Devices (SHPDDs). What is desired is a charging system untethered from wires and freed from any stationary, fixed location which can enable fast AC transfer and fast DC charging at a high rate of energy transfer. Further desired is an energy transfer system that allows for dynamic power transfer to a vehicle in motion where the transferred power may be used to recharge batteries, or directly power the electric motors that propel the vehicle, or both. Also desired is a charging infrastructure that enables auto manufacturers to use smaller, lighter weight batteries.

Further, there is a growing need for a large number of devices and, in particular, electric motorized vehicles to be able to progress without interruption from a state of stationary charge delivery and energy consumption instantaneously to a state of dynamic charge delivery which can sustain continuous energy consumption and thusly provide motion flexibility to the user without any concern for power management tradeoffs. The novel devices of the present invention provide for this need.

U.S. patent application Ser. No. 13/999,054 filed Jan. 8, 2014, generically discloses an apparatus having management of electrical power capacity regions and management of thermal capacity regions.

U.S. patent application Ser. No. 14/447,822 filed Jul. 31, 2014, generically discloses composite interconnect accessory rail system.

U.S. patent application Ser. No. 14/955,642 filed Dec. 1, 2015, generically discloses armament with wireless charging apparatus and methodology.

U.S. patent application Ser. No. 14/984,003 filed Dec. 30, 2015, generically discloses charging apparatus and methodology.

### BRIEF SUMMARY

Disclosed herein is an energy transfer apparatus comprising at least one energy source, at least one induction transmission coil member, and at least one electrical conductor; wherein the at least one energy source, the at least one induction transmission coil member, and the at least one electrical conductor are connected to a convention power source to comprise an inductive power transmission system.

Disclosed herein is an energy transfer apparatus comprising at least one primary induction receiving unit, at least one primary induction transmission unit, and at least one electrical conductor; wherein at least one of the at least one primary induction receiving unit, the at least one electrical conductor, and the at least one primary induction transmission unit are configured to form an integrated system.

Disclosed further herein is an energy transfer apparatus comprising at least one primary induction receiving unit, at least one primary induction transmission unit, and at least one electrical conductor; wherein at least one of the at least one primary induction transmitting unit, the at least one electrical conductor, and the at least one primary induction receiving unit is enveloped completely, or partially, in a polymer-based host resin to comprise an advanced composite system

Further disclosed herein is an energy transfer apparatus comprising at least one primary induction receiving unit, at least one primary induction transmission unit, and at least one electrical conductor; wherein at least one of the at least one primary induction transmitting unit, and the at least one primary induction receiving unit, and at least one electrical conductor; comprises an integrated system where electrical power across a broad spectrum may be delivered while at least one of these units is in motion

The motion disclosed above may be in any preselected direction and at any preselected velocity, and, either the predetermined direction or the predetermined velocity, or both may be variable or held constant.

Further disclosed herein is an energy transfer apparatus comprising at least one primary induction receiving unit, at least one primary induction transmission unit, and at least one electrical conductor; wherein at least one of the at least one primary induction transmitting unit, and the at least one primary induction receiving unit, while in motion may occupy a space and location having a pre-established relationship to each another.

Further disclosed herein is an energy transfer apparatus comprising at least one primary induction receiving unit, at least one primary induction transmission unit, and at least one electrical conductor; wherein at least one of the at least one primary induction transmitting unit, and the at least one primary induction receiving unit, while in motion may sustain a gap or spacing that serves to separate the primary induction receiving unit from the primary induction transmission unit.

Further disclosed herein is an energy transfer apparatus comprising at least one primary induction receiving unit, at least one primary induction transmission unit, and at least one electrical conductor; wherein at least one of the at least one primary induction transmitting unit, and the at least one primary induction receiving unit comprises an integrated system where electrical power across a broad spectrum may be delivered across a physical spacing or gap wherein the gap is configured to accommodate a flow of at least one of; a gas, air, a fluid, a liquid, a stream of fine particles, solid particles suspended in a gas, or combinations thereof.

Further disclosed herein is an energy transfer apparatus comprising at least one primary induction receiving unit, at least one primary induction transmission unit, and at least one electrical conductor; wherein at least one of the at least one primary induction transmitting unit, and the at least one primary induction receiving unit comprises an integrated system where electrical power across a broad spectrum may be delivered across a physical spacing or gap wherein the gap is configured to accommodate a flow of at least one of; a gas, air, a fluid, a liquid, a stream of fine particles, solid particles suspended in a gas, or combinations thereof whereby the flow is configured to provide dynamic thermal management to at least one of the units.

Further disclosed herein is an energy transfer apparatus kit comprising an energy transfer apparatus that may be connected to at least one energy source; wherein the energy transfer apparatus comprises at least one primary induction transmitting unit, and at least one electrical conductor; and at least one polymer-based resin to comprise an advanced composite structure.

Further disclosed herein is an energy transfer apparatus kit comprising an energy transfer apparatus that may be connected to at least one energy source; wherein the energy transfer apparatus comprises at least one primary induction transmitting unit, at least one electrical conductor, and a power control apparatus; and at least one polymer-based resin to comprise an advanced composite structure.

Further disclosed herein is an energy transfer apparatus kit comprising an energy transfer apparatus that may be connected to at least one energy source; wherein the energy transfer apparatus comprises at least one primary induction transmitting unit, at least one electrical conductor, a data transceiver device, and a power control apparatus; and at least one polymer-based resin to comprise an advanced composite structure.

Further disclosed herein is an energy transfer apparatus kit comprising an energy transfer apparatus that may be connected to at least one energy source; wherein the energy transfer apparatus comprises at least one primary induction transmitting unit, at least one electrical conductor, at least one thermal conductor; and at least one polymer-based resin to comprise an advanced composite structure.

Further disclosed herein is an energy transfer apparatus kit comprising an energy transfer apparatus that may be connected to at least one energy consuming device; wherein the energy transfer apparatus comprises at least one primary induction receiving unit, and at least one electrical conductor; and at least one polymer-based resin material to comprise an advanced composite structure.

Further disclosed herein is an energy transfer apparatus kit comprising an energy transfer apparatus that may be connected to at least one energy consuming device; wherein the energy transfer apparatus comprises at least one primary induction receiving unit, at least one electrical conductor, a data transceiver device; and at least one polymer-based resin material to comprise an advanced composite structure.

Further disclosed herein is an energy transfer apparatus kit comprising an energy transfer apparatus that may be connected to at least one energy consuming device; wherein the energy transfer apparatus comprises at least one primary induction transmitting unit, at least one electrical conductor, at least one thermal conductor; and at least one polymer-based resin material to comprise an advanced composite structure.

Further disclosed herein is an energy transfer apparatus kit comprising an energy transfer apparatus that may be connected to at least one energy consuming device; wherein the energy transfer apparatus comprises at least one primary induction receiving unit, and at least one electrical conductor, a power control apparatus; and at least one polymer-based resin material to comprise an advanced composite structure.

Further disclosed herein is an energy transfer apparatus kit comprising an energy transfer apparatus that may be connected to at least one energy source; wherein the energy transfer apparatus comprises at least one primary induction transmitting unit, and at least one electrical conductor; and at least one polymer-based resin to comprise an advanced composite structure wherein the advanced composite structure may be affixed to a moving vehicle. The vehicle may be any suitable platform that is capable of movement, for example; large semi-tractor trailers, cargo vans, vans, self-contained motorized campers, pickup and other trucks, vehicle towable trailers of any size, carts, wagons, ships, barges, aircraft, people, and other platforms capable of motion and transport.

Further disclosed herein is an energy transfer apparatus kit comprising an energy transfer apparatus that may be connected to at least one energy source; wherein the energy transfer apparatus comprises at least one primary induction receiving unit, and at least one electrical conductor; and at least one polymer-based resin to comprise an advanced composite structure wherein the advanced composite structure may be affixed to a moving vehicle. The vehicle may be any suitable platform that is capable of movement, for example; large semi-tractor trailers, cargo vans, vans, self-contained motorized campers, pickup and other trucks, vehicle towable trailers of any size, carts, wagons, ships, barges, aircraft, people, and other platforms capable of motion and transport.

Further disclosed herein is an energy transfer apparatus kit comprising an energy transfer apparatus that may be connected to at least one energy consuming device; wherein the energy transfer apparatus comprises at least one primary induction receiving unit, and at least one electrical conductor; and at least one polymer-based resin material to comprise an advanced composite structure.

Further disclosed herein is an energy transfer apparatus kit comprising an energy transfer apparatus, at least one induction energy source, and at least one secondary induction receiving unit; wherein the energy transfer apparatus comprises at least one primary induction receiving unit, at least one primary induction transmission unit, and at least one electrical conductor; wherein the at least one secondary induction receiving unit comprises at least one induction chargeable device; wherein at least one of the at least one primary induction receiving unit, the at least one electrical conductor, and the at least one primary induction transmission unit comprises an advanced composite material; and wherein the energy transfer apparatus is an integrated system.

Further disclosed herein is an energy transfer apparatus comprising at least one primary induction receiving unit, at least one primary induction transmission unit, and at least one electrical conductor; wherein the energy transfer apparatus is an integrated system capable of dynamic charge transfer when the transmitting unit and the receiving unit are affixed to a vehicle that is capable of motion. The vehicle may be any suitable platform that is capable of movement, for example; large semi-tractor trailers, cargo vans, vans, self-contained motorized campers, pickup and other trucks, vehicle towable trailers of any size, carts, wagons, ships, barges, aircraft, people, and other platforms capable of motion and transport.

Further disclosed is an energy transfer kit comprising at least one polymer-based resin along with appropriate other functional components of the energy transfer system wherein the constituent components of the inductive energy transfer system are encased within the polymer-based resin to form a weather-resistant energy transfer kit.

Further disclosed herein is a method of wireless inductive charge transfer, the method comprising bringing at least one induction energy source in proximity with at least one primary induction receiving unit and transmitting energy from the at least one induction energy source to the at least one primary induction receiving unit; the at least one primary induction receiving unit conducting energy via at least one electrical conductor to at least one power utilizing device.

Further disclosed herein is a method of dynamic wireless inductive charge transfer, the method comprising bringing at least one induction energy source that is mounted onto, attached upon, or carried within a first moving vehicle in proximity with at least one primary induction receiving unit that is mounted onto, attached upon, or carried within a second moving vehicle and transmitting energy from the at least one induction energy source that is in motion and moving in a predetermined relationship between the first and the second vehicles to the at least one primary induction receiving unit; the at least one primary induction receiving unit conducting energy via at least one electrical conductor to at least one power utilizing device.

Further disclosed herein is a method of wireless inductive charge transfer, the method comprising bringing at least one induction energy source in proximity with at least one primary induction receiving unit and transmitting energy from the at least one induction energy source to the at least one primary induction receiving unit; the at least one primary induction receiving unit conducting energy via at least one electrical conductor to at least one secondary induction transmitting unit; bringing at least one secondary induction receiving unit in proximity with the at least one secondary induction transmitting unit; and providing energy to power at least one induction powered device having a secondary induction receiving unit.

Further disclosed herein is a method of dynamic wireless inductive charge transfer comprising bringing at least one induction energy source that is mounted onto, attached upon, or carried within a first moving vehicle in proximity with at least one primary induction receiving unit that is mounted onto, attached upon, or carried within a second moving vehicle and transmitting energy from the at least one induction energy source that is in motion and moving in a predetermined relationship between the first and the second vehicles to the at least one primary induction receiving unit; the at least one primary induction receiving unit conducting energy via at least one electrical conductor to at least one power utilizing device and repeating the described method a sufficient number of times to enable long-distance travel of any desired length without stopping for a static battery recharge event at a fixed location.

Further disclosed herein is a method of wireless inductive charge transfer, the method comprising connecting at least one induction energy source kit to a power source and bringing at least one induction energy source kit in proximity with at least one primary induction receiving kit and transmitting energy from the at least one induction energy source kit to the at least one primary induction receiving kit; the at least one primary induction receiving kit conducting energy via at least one electrical conductor to at least one secondary induction transmitting kit; bringing at least one secondary induction receiving kit in proximity with the at least one secondary induction transmitting kit; and providing energy to power at least one induction powered device having a secondary induction receiving kit.

Other systems, methods, features and advantages of the invention will be, or will become, apparent to one with skill in the art upon examination of the following figures and detailed description. It is intended that all such additional systems, methods, features, and advantages be included within this description, be within the scope of the invention, and be protected by the claims that follow. The scope of the present invention is defined solely by the appended claims and is not affected by the statements within this summary.

### BRIEF DESCRIPTION OF THE FIGURES

The invention can be better understood with reference to the following drawings and description. The components in the figures are not necessarily to scale, emphasis instead being placed upon illustrating the principles of the invention.

FIG. 1A is a functional block diagram of a wireless induction energy transfer system comprising an induction energy source and an energy receiving apparatus of the present invention;

FIG. 1B is block diagram of a more complex exemplary wireless induction energy transfer system comprising an energy transfer apparatus of the present invention;

FIG. 2 depicts an exemplary wireless induction energy transfer system comprising the apparatus of FIG. 1B configured comprised of a transmitting unit configured to provide induction transferred energy to a plurality of devices, accessories, or vehicles;

FIG. 3 is an illustration of an exemplary wireless induction energy apparatus comprising a primary power control unit, an integrated power storage and supply unit, a second power control unit, a primary receiving unit, and a transmitting unit;

FIG. 4 is an illustration of an exemplary wireless induction energy apparatus configured to transfer a plurality of energy types to a plurality of devices, accessories, or vehicles at a plurality of locations;

FIG. 5 is an illustration of an exemplary apparatus configured to transfer energy to a plurality of devices, accessories, or vehicles in a parallel arrangement;

FIG. 6 is an illustration of an exemplary inductive charge transfer apparatus comprising a plurality of advanced composite structures and advanced composite materials that form synergistically interacting regions and sub-regions; and

FIG. 7 is an illustration of an exemplary advanced composite comprising an inductive receiving and control unit, an inductive transmitting unit, and a conductive interconnecting unit wherein the units are integrated with a suitable polymer-based resin to form an integrated advanced structure. The key components enveloped within a polymer-based resin as illustrated may comprise a lightweight, weather-resistant kit.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures. The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Elements of a dynamic energy transfer network are disclosed herein which take advantage of, and capture advantages provided by, over-the-road transport vehicles reconfigured with the inventive charge delivery apparatus of the present invention interconnected wirelessly with adjacent power requiring vehicles that may remain in motion for extended periods of time. A noteworthy advantage of the inventive dynamic charging system is that numerous, energy transfer events of comparatively short duration may be relied upon during a long-road trip to power the vehicular motion and/or recharge the batteries while the vehicle remains in motion. Thus, the energy requirement of the on-board battery may be substantially reduced as only sufficient energy to sustain only an initial portion of the entire trip is needed. This advantage not only reduces the requirements for large, heavy battery packs but also provides the vehicle operator with many more trip planning options. It is conceivable that a long trip in a vehicle may, as deemed appropriate by the operator, employ a large number of short duration, dynamic charge transfer events, for example dozens or perhaps one every 50 to 100 travel miles. These events would occur with minimal participation from the operator and would be nearly transparent to the operator.

A system of inductor parings and associated circuitry is described herein that may be used for non-contact, wireless, dynamic energy transfer of low as well as high power levels, for example in the range of less than 1 Watt (W) to 500+Kilowatts (KW), as well as for contactless secondary re-transfer of the source power that allows for interconnecting more than one power requiring devices in more than one location. Further described herein are various apparatus and means for non-contact charge transfer at multiple locations and at variable distances while each of, at least one each of, a power source and a power requiring device may be stationary or in motion. In the case where two, or more, inductor pairs are in synchronous motion, this configuration of devices may be referred to as a dynamic, high power delivery device (DHPDD). Thusly defined, these novel devices provide the capability for dynamic wireless inductive charge transfer of the present invention.

As utilized herein, the following terms and expressions will be understood as follows:

The terms “a” or “an” are intended to be singular or plural, depending upon the context of use.

The term “about” as utilized herein refers to the statistically average variability as is typically found in the art of the invention herein.

The expression “accessibly embedded contact surface” refers to a substrate, region, sub-region, or micro-domain of an electrically and/or thermally conductive material encased within a second material to enable contact to be made between at least a portion of the embedded electrical and/or thermal conductor, i.e., the interconnect, and an external contact substrate to complete an electrical and/or thermal circuit.

The term “accessory” refers to any device requiring electrical power capable of connecting directly or indirectly to a power source.

The term “advanced” refers to a system or material that due to its composition, design, or use is at, or performs at, a level that is above a generally accepted norm or base of comparison. In some instances, it refers to a higher level of complexity when compared to common or contemporary systems, materials, methods, or ideas.

The expression “advanced composite” means a material comprised of at least two different materials configured or combined in such a manner whereby specific properties of the combination supersede the properties of each of the constituent components. In some cases, an advanced composite may be capable of replacing metals. For example, the thermal conductivity of some advanced composites may equal or exceed that of certain metals, such as aluminum, iron, or steel. Advanced composites may be created by combining at least one filler component, usually a reinforcing filler component, with a compatible polymer-based resin system. The advanced composite may take on any form, e.g., a rigid solid, a semi-rigid solid, a flexible solid, a structural foam, and the like, and may be configured into functional shapes and configurations.

The expression “advanced composite material” refers to a composition of matter comprised of a resin material and at least one filler material. Typically, the filler works in concert with the resin matrix to provide or contribute to a critical property of the composite. Examples of such critical properties include high strength, high stiffness, and high modulus of elasticity, electrical conductivity, thermal conductivity, and low specific density when compared to other common materials. Examples of resin matrix materials may include: polymers, ceramics, glasses, cements, metals as well as blends and combinations thereof. Examples of filler materials include: carbon fiber(s), carbon nanotubes, fiberglass, metal fibers, fine metal filaments, metal wires, polymeric fibers including fine polymeric fibers, mineral fibers, basalt fibers, metalized carbon fibers, metalized carbon nanotubes, metalized glass, metalized basalt, metalized mineral fibers, natural fibers, metalized natural fibers, composite fibers, graphene-based filaments, and mixtures and combinations thereof. The filler materials may include: wires, fibers, or filaments such as; solid fibers, hollow fibers, bi component fibers, multicomponent fibers, single or multilayered fibers, optical fibers and may be of any size, shape, or geometric configuration, and may have any surface topography and may be rigid, semi rigid, flexible, elastic, or porous and combinations thereof.

The expression “advanced composite structure” means a physical member comprised of at least one advanced composite material.

The expression “critical property” refers to at least one physical, mechanical, electrical, or thermal property of a composite that enables the advanced composite material to provide the desired functionality when used in a specific application.

The expression “electrical conductor” means a wire, cable, fiber, filament, or similar object capable of conducting an electrical charge.

The expression “electrical contact” refers to one-half of a contact pair consisting of an electrically conductive surface that may be electrically connected to at least one second electrical contact to form a circuit to permit flow of electrical current.

The expression “electrical conduit” refers to a pathway in, through and/or around a conductive material that is capable of conveying current or transporting electrical or electrostatic charge.

The expressions “electrical interconnect” or “electrical interconnection,” refers to physical contact or near contact between two or more electrical conduits enabling passage of current or transport of charge(s). In certain instances, it refers to the interface substrate between two, or more electrical conduits. In certain other instances it refers to a spacing or gap therethrough which passage of current or transport of charge(s) may occur.

The expression “electrically insulating” means an electrically resistive material having a high effective electrical resistance, for example having a d.c. volume resistivity in the range greater than about 10⁶ ohm-m and having a capability to prevent the flow of current in one, or more parts of the circuit or between adjacent circuits.

The expression “electrical power management” shall be understood to be a process of exercising control, via manual, semiautomated, or automated means, to achieve or sustain a predetermined level of electrical energy.

The expressions “electrical powered device”, “energy consuming device”, and “energy utilizing device” are similar terms referring to any apparatus, accessory, device, and the like which require electrical energy of any form and at any level to operate.

The terms “induction” or “inductive” when used in conjunction within an expression shall be understood to encompass both magnetic induction and magnetic resonance.

The expression and term “induction coil” or “coil′ shall refer to a conductive material which is wound one or more times or otherwise shaped, molded, printed, electroformed, plated, or configured to form a spiral, a generally circular pattern, or similar form. Typically, the coil will have at least two contact regions generally located at the coil end regions where connection to an electrical circuit can be made to enable power to be provided to a power using accessory or to accept power from a power source. In order to achieve a high desired level of wireless inductive charging performance the material may be wound at least two times around a suitable core material, wherein the core is made of any suitable solid, liquid, gaseous, plasma, or intermediate material.

The expression “induction chargeable device” shall refer to a device which may have a power storage unit chargeable by energy from an induction receiving unit, and where the device may operate on the energy provided by the power storage unit, provided directly from energy received by the induction energy unit, or combinations thereof.

The expression “induction energy source” shall include any source of induction energy power, including but not limited to, batteries, battery banks, induction charging pads, power storing capacitors, super capacitors, fuel cells, solar cells, generators, portable generators, electrical outlets, and the like.

The expressions “induction grid” or “grid′ shall refer to conductive material which is configured in a 2-dimension or 3-dimension geometric pattern where the material has at least two terminal ends of the conductive material for a continuous electric circuit. The grid may be fabricated into a sheet form by any suitable process such as hand lay-up, casting, knitting, weaving, braiding, and the like. The term “grid”, when referred to as “integrated grid”, refers to an assembly of coils and/or loops that are configured into a network where power transfer can occur at one, or more, positions across or within the network.

The expressions “induction loop” or “loop′ shall refer to conductive material which is formed in a general pattern having any geometric shape, such as a generally circular pattern, an elongated oval, an oblong shape, a square-shape, a rectangular shape, a triangular shape and the like.

The expression “induction member” shall refer to an induction coil, induction loop, induction grid, or combinations thereof.

The expression “induction transmission unit” shall refer to an induction energy transmitter along with related circuitry, and optionally, a power management controller, and optionally, a thermal management controller.

The expression “induction receiving unit” shall refer to a receiving circuit comprising an induction member, a power management controller and a thermal management controller.

The term “integrated” refers to a structural system which is organized such that the constituent units function cooperatively.

The expression “integrated system” refers to an apparatus wherein the component parts, either on or within a structural feature are organized so that the parts are capable of functioning cooperatively.

The expression “integrated structural system” means two or more structural features combined into a unit. In preferred embodiments, the combination of two or more advanced composites creates an enhancement to, or synergy between one or more critical properties such as mechanical strength, impact resistance, abrasion resistance, modulus of elasticity, electrical conductivity, thermal conductivity, and relative density, and the like.

The term “kit” is intended to mean a group of items that are kept or housed together because they are collectively used for a defined specific purpose.

The expression “managing electrical energy” means the control of movement, removal, storage, or regulation of electrical energy.

The expression “managing thermal energy” means the control of movement, removal, storage or regulation of thermal energy.

The term “polymer-based resin” includes, but is not limited to any organic molecule or large molecule made up of chains or rings of linked monomer units including, but not limited to: polyurethane, nylon, polyester, polyimide, epoxy, silicone, fluoropolymers, as well as copolymers, blends and mixtures thereof.

The term “power control unit” as utilized herein is an object capable of receiving and/or transmitting electrical and/or thermal energies and shall mean a circuit member capable of at least one of; sensing, measuring, or modulating an electrical and/or thermal energy.

The expression “personally portable” includes that which can be carried by a person or by a person with minimal aid, such as but not limited to, with the aid of a service animal or carrying device.

The expression “personally portable container” is a carrying device which partially or fully encloses a personally portable object or device and aids in making the object or device personally portable. A personally portable container may itself be hand-held, wearable, or a combination thereof.

The term “plurality” is meant and used herein to mean more than one.

The expression “power storage unit” shall refer to a device capable of storing electrical charge, such as a battery, capacitor, or the like.

The term “region” as utilized herein is the functional portion of the wireless induction charge transfer apparatus with a defined separate response to the functional requirements and/or stimulus.

The term “reinforcing” refers to the effect of one material when combined with at least one second material that results in strengthening, fortification, and/or improvement of at least one characteristic or property of the material or the combination of materials.

The term “substrate” refers to a base layer or a layer that is underneath a subsequent layer. It can also refer to a surface onto which a second material such as a coating, a finish, a paint, a catalyst, a metal layer, insulating layer, or combinations thereof which is applied.

The expression “thermal conductor” refers to any material that conveys or conducts heat.

The expression “thermal conduits” refers to any material that conveys or conducts heat.

The term “thermal contact” refers to one-half of a contact pair consisting of an electrically or thermally conductive surface that may be thermally connected to at least one second thermal contact to form a circuit to permit flow of electrical and/or thermal energy.

The expressions “thermal interconnect” and “thermal interconnection” refer to the physical contact or near contact between two, or more thermal conduits that enables passage of heat. In certain instances, they refer to the interface region between two, or more thermal conduits.

The expression “thermal power management” shall be understood to be a characteristic of the advanced composite material where the advanced composite material has regions for thermal conduction and regions for thermal insulation and where thermal energy transmission can be controlled using the thermal conduction and insulation properties of the advanced composite material.

The term “transceiver” refers to an electronic device or circuit that transmits and receives analog or digital signals, either wired or wireless.

The terms “weather-resistant” and ‘weatherproof’ are used interchangeably and are meant to describe a condition of said apparatus or item to tolerate without impact to the functionality of the apparatus or deleterious change to the item upon a predefined exposure to an adverse environment that may comprise, heat, excessive heat, cold, excessive cold, dry conditions, excessive dry conditions, wet or moist conditions, excessive wet conditions, direct sunshine, and the like.

The term “vehicle” refers to a machine used for transporting people or goods. The vehicle may be any suitable platform that is capable of movement, for example; large semi-tractor trailers, cargo vans, vans, self-contained motorized campers, pickup and other trucks, vehicle towable trailers of any size, carts, wagons, ships, barges, aircraft, people, and other platforms capable of motion and transport.

The present invention may be an energy transfer apparatus comprising at least one primary induction receiving unit, at least one primary induction transmission unit, and at least one electrical conductor; wherein at least one of the at least one primary induction receiving unit, the at least one electrical conductor, and the at least one primary induction transmission unit comprises an integrated system. The energy transfer apparatus may have at least one power control unit. The energy transfer apparatus may have at least one power control unit comprising an advanced composite structure. The energy transfer apparatus may have at least one power storage unit. The energy transfer apparatus may have at least one primary induction receiving unit and at least one primary induction transmission unit comprising a circuit configuration connected in series, in parallel, or a combination thereof. The energy transfer apparatus may have at least one primary induction receiving unit, at least one primary induction transmission unit, at least one power control unit, and at least one power storage unit comprising a circuit configuration connected in series, in parallel, or combination thereof.

The energy transfer apparatus may be an advanced composite structure. The energy transfer apparatus may have at least one induction energy source. The energy transfer apparatus may have at least one induction energy source and comprise an energy transfer kit. The energy transfer apparatus may have at least one induction receiving unit comprising at least one induction powered device. The energy transfer apparatus may have at least one induction receiving unit comprising at least one induction chargeable device. The energy transfer apparatus may have at least one induction receiving unit comprising at least one induction energy utilizing device. The energy transfer apparatus may further have an advanced composite material forming an electrical power management region and a second advanced composite material forming a thermal energy management region to comprise an advanced material system. The energy transfer apparatus where the advanced composite material comprises at least one thermal conductor. The energy transfer apparatus may have at least one induction receiving unit comprising at least one energy transfer kit. The energy transfer apparatus may have at least one secondary induction receiving unit comprising at least one induction powered device. The energy transfer apparatus may have at least one secondary induction receiving unit comprising at least one induction chargeable device.

In one embodiment, the present invention disclosed herein may be an energy transfer apparatus comprising at least one induction energy source, at least one electrical conductor, and at least one primary induction receiving unit, where the at least one induction energy source, the at least one electrical conductor, and the at least one primary induction receiving unit comprises an integrated system. In a further embodiment, the present invention disclosed herein may be an energy transfer apparatus comprising at least one induction energy source; wherein the energy transfer apparatus comprises at least one electrical conductor, at least one polymer-based resin, and at least one primary induction receiving unit, where the at least one electrical conductor, at least one polymer-based resin, and the at least one primary induction receiving unit comprises an advanced composite structure.

In a further embodiment, the present invention disclosed herein may be an energy transfer apparatus connected to at least one induction energy source; wherein the energy transfer apparatus comprises at least one primary induction transmission unit, at least one energy control unit, and at least one electrical conductor; wherein the at least one electrical conductor, the at least one energy control unit, and the at least one polymer-based resin comprises an integrated system.

In a further embodiment, the present invention disclosed herein may be an energy transfer apparatus connected to at least one induction energy source; wherein the energy transfer apparatus comprises at least one primary induction receiving unit, at least one polymer-based resin, and at least one electrical conductor; wherein at least one of the at least one primary induction receiving unit, the at least one electrical conductor, and the at least one polymer-based resin comprises an advanced composite system. In a further embodiment, the present invention disclosed herein may be an energy transfer apparatus kit comprising an energy transfer apparatus; wherein the energy transfer apparatus comprises at least one primary induction transmission unit, at least one energy control unit, and at least one electrical conductor comprises an integrated system. In a further embodiment, the present invention disclosed herein may be an energy transfer apparatus kit comprising an energy transfer apparatus; wherein the energy transfer apparatus comprises at least one primary induction transmission unit, at least one energy control unit, and at least one electrical conductor, and the at least one polymer-based resin to comprise an advanced composite system. In a further embodiment, the present invention disclosed herein may be an energy transfer apparatus comprising an energy transfer apparatus, and at least one induction energy source; wherein the energy transfer apparatus comprises at least one primary induction receiving unit, at least one primary induction transmission unit, and at least one electrical conductor; wherein at least one of the at least one primary induction receiving unit, the at least one electrical conductor, and the at least one primary induction transmission unit are configured to transfer energy while in dynamic motion.

In a further embodiment, the present invention disclosed herein may be an energy transfer apparatus kit comprising an energy transfer apparatus and at least one electrical conductor and at least one primary induction receiving unit, where the at least one electrical conductor, and the at least one primary induction receiving unit comprises an advanced composite system capable of receiving electrical energy while in motion whereby the kit may be affixed to a vehicle capable of motion. The vehicle may be any suitable platform that is capable of movement, for example; large semi-tractor trailers, cargo vans, vans, self-contained motorized campers, pickup and other trucks, vehicle towable trailers of any size, carts, wagons, ships, barges, aircraft, people, and other platforms capable of motion and transport. In a further embodiment, the present invention disclosed herein may be an energy transfer kit comprising at least one of; comprising an energy transfer apparatus, and at least one induction energy source, at least one non-inductive source of energy, and at least one conductive wire wherein the kit is capable of inductive charge transfer while in motion. In a further embodiment, the present invention disclosed herein may be an energy transfer apparatus kit comprising an energy transfer apparatus, and at least one induction energy source; wherein the energy transfer apparatus comprises at least one electrical conductor and at least one primary induction transmitting unit, where the at least one electrical conductor, and the at least one primary induction transmitting unit comprises an advanced composite system capable of transmitting electrical energy while in motion.

The energy transfer apparatus kit may further have an advanced composite material with at least two regions; wherein at least one first region of the advanced composite material is a first advanced composite material forming an electrical power management region, and, at least one second region of the advanced composite material is an advanced composite material forming a thermal energy management region wherein that configuration of regions provides for management of both electrical and thermal energy within the kit. The energy transfer apparatus kit may have at least one power control unit comprising an advanced composite system. The energy transfer apparatus kit may have at least one power storage unit. The energy transfer apparatus kit may have at least one primary induction receiving unit and at least one primary induction transmission unit comprising a circuit configuration connected in series, in parallel, or a combination thereof. The energy transfer apparatus kit may have at least one primary induction receiving unit, at least one primary induction transmission unit, at least one power control unit, and at least one power storage unit comprising a circuit configuration connected in series, in parallel, or combination thereof. The energy transfer apparatus kit may be an advanced composite structure. The energy transfer apparatus kit may have at least one secondary induction receiving unit comprising at least one induction chargeable device.

In a further embodiment, the invention disclosed herein may be an energy transfer apparatus kit comprising an energy transfer apparatus, and at least one secondary induction receiving unit; wherein the energy transfer apparatus comprises at least one primary induction receiving unit, at least one primary induction transmission unit, and at least one electrical conductor; wherein the at least one secondary induction receiving unit comprises at least one induction chargeable device; wherein at least one of the at least one primary induction receiving unit, the at least one electrical conductor, and the at least one primary induction transmission unit comprises a dynamic wireless inductive charge transfer system. The energy transfer apparatus kit where the advanced composite material comprises at least one thermal conductor. The energy transfer apparatus kit may have at least one power control unit comprising an advanced composite material. The energy transfer apparatus kit may have at least one power storage unit. The energy transfer apparatus kit may have at least one primary induction receiving unit and at least one primary induction transmission unit comprising a circuit configuration connected in series, in parallel, or a combination thereof. The energy transfer apparatus kit may have at least one primary induction receiving unit, at least one primary induction transmission unit, at least one power control unit, and at least one power storage unit comprising a circuit configuration connected in series, in parallel, or combination thereof. The energy transfer apparatus kit may be an advanced composite structure. The energy transfer apparatus kit may use at least one induction energy source.

In a further embodiment, the invention disclosed herein may be an energy transfer apparatus kit comprising an energy transfer apparatus, at least one induction energy source, and at least one secondary induction receiving unit; wherein the energy transfer apparatus comprises at least one primary induction receiving unit, at least one primary induction transmission unit, and at least one electrical conductor; wherein at least one secondary induction receiving unit comprises at least one induction chargeable device; wherein at least one of the at least one primary induction receiving unit, the at least one electrical conductor, and the at least one primary induction transmission unit comprises an advanced composite material; and wherein the energy transfer apparatus is an integrated system. The energy transfer apparatus kit may further have an advanced composite material with at least two regions; wherein at least one first region of the advanced composite material is an advanced composite material forming an electrical power management region, an advanced composite material forming an electrical power management sub-region, an advanced composite material forming an electrical power management micro domain or combinations thereof; and wherein at least one second region of the advanced composite material is an advanced composite material forming a thermal energy management region, an advanced composite material forming a thermal energy management sub-region, an advanced composite material forming a thermal energy management micro domain or combinations thereof. The energy transfer apparatus kit where the advanced composite material comprises at least one thermal conductor. The energy transfer apparatus kit may have at least one power control unit comprising an advanced composite material. The energy transfer apparatus kit may have at least one power storage unit. The energy transfer apparatus kit may have at least one primary induction receiving unit and at least one primary induction transmission unit comprising a circuit configuration connected in series, in parallel, or a combination thereof.

The energy transfer apparatus kit may have at least one primary induction receiving unit, at least one primary induction transmission unit, at least one power control unit, and at least one power storage unit comprising a circuit configuration connected in series, in parallel, or combination thereof. The energy transfer apparatus kit may be an advanced composite structure. In a further embodiment, the invention disclosed herein is an energy transfer apparatus comprising at least one primary induction receiving unit, at least one primary induction transmission unit, and at least one electrical conductor; wherein the energy transfer apparatus is an integrated system. The energy transfer apparatus may use at least one induction energy source. The energy transfer apparatus may have at least one secondary induction receiving unit comprising at least one induction chargeable device. The energy transfer apparatus may have at least one power control unit and at least one power storage device. The energy transfer apparatus may have at least one primary induction receiving unit and at least one primary induction transmission unit connected in series, in parallel, or combinations thereof. The energy transfer apparatus may have at least one primary induction receiving unit, at least one primary induction transmission unit, at least one power control unit, and at least one power storage device are connected in a circuit configuration selected from a group consisting of in series, in parallel, and combinations thereof.

Further disclosed herein is a method of wireless inductive charge transfer, the method comprising bringing at least one induction energy source in proximity with at least one primary induction receiving unit and transmitting energy from the at least one induction energy source to the at least one primary induction receiving unit; the at least one primary induction receiving unit conducting energy via at least one electrical conductor to at least one power utilizing device. Further disclosed herein is a method of dynamic wireless inductive charge transfer, the method comprising bringing at least one induction energy source that is mounted onto, attached upon, or carried within a first moving vehicle in proximity with at least one primary induction receiving unit that is mounted onto, attached upon, or carried within a second moving vehicle and transmitting energy from the at least one induction energy source that is in motion and moving in a predetermined relationship between the first and the second vehicles to the at least one primary induction receiving unit; the at least one primary induction receiving unit conducting energy via at least one electrical conductor to at least one power utilizing device. Further disclosed herein is a method of wireless inductive charge transfer, the method comprising bringing at least one induction energy source in proximity with at least one primary induction receiving unit and transmitting energy from at least one induction energy source to at least one primary induction receiving unit; at least one primary induction receiving unit conducting energy via at least one electrical conductor to at least one secondary induction transmitting unit; bringing at least one secondary induction receiving unit in proximity with at least one secondary induction transmitting unit; and providing energy to power at least one induction chargeable device having a secondary induction receiving unit. The method of wireless inductive charge transfer may include a data signal provided to at least one induction chargeable device having a secondary induction receiving unit. The method of wireless inductive charge transfer may include connection of at least one primary charge transmitter unit to at least one power source, ad that the at least one power source may deliver power in the range of 0.1 KW to 500 KW alternating current having a range of frequencies of about 1 to about 500 kilohertz to the primary charge transmitter. The method of wireless inductive charge transfer may have at least one primary induction receiving unit transmitting energy to at least one power control unit; at least one power control unit transmitting energy to at least one power storage device; and at least one power storage device transmitting energy to at least one primary induction transmission unit. The method of wireless inductive charge transfer may have at least one primary induction receiving unit configured to receive energy from at least one induction energy source. The method of wireless inductive charge transfer may have at least one primary induction receiving unit configured to receive energy from at least one induction energy source while in motion. The method of wireless inductive charge transfer may have at least one secondary induction receiving unit configured to receive energy from at least one primary induction transmission unit. The method of wireless inductive charge transfer may have at least one secondary induction receiving unit configured to receive energy from at least one primary induction transmission unit while in motion.

One basic configuration may comprise at least two pairs of inductor coil members, the first pair representing an energy transmission member and an energy receiving member, connected to a second pair representing an energy transmission member and an energy receiving member. The two pairs of induction members are connected, along with associated control circuitry. There may also be multiple second pairs of energy transmission members and receiving members. Any of the pairings may be configured to function while in motion and while in motion may occupy a space and location having a pre-established relationship to each another. There may be a configuration whereby the first pair comprises one energy transmission member and multiple energy receiving members, connected to and conducting energy to a second pair of inductor coil members. A variant of this configuration may be a first pair with multiple energy transmission members and a single energy receiving member, connected to and conducting energy to a second pair of inductor coil members. There may be an equal or unequal number of energy transmission members and energy receiving members in the first pair of induction coil members.

The various configurations of the first induction coil member pair may be combined with multiple configurations of the second pair of induction coil members. There may be a configuration whereby the second pair comprises one energy transmission member and multiple energy receiving members, connected to and receiving energy from a first pair of inductor coil members. A variant of this configuration may be a second pair with multiple energy transmission members and a single energy receiving member, connected to and receiving energy from a first pair of inductor coil members. There may be an equal or unequal number of energy transmission members and energy receiving members in the second pair of induction coil members.

The energy transmission member in the first pair may be part of or a component of an energy transmission unit. The energy transmission unit may comprise one or more induction transmission members. The energy transmission unit may be part of or a component or an energy source. The energy transmission unit may be an energy transmission kit. The energy receiving member in the first pair may be part of or a component of an energy receiving unit. The energy receiving unit may comprise one or more energy receiving members. The energy transmission unit may be an energy receiving kit. A possible configuration for the first pair of induction coil members may include an energy source and an energy receiving unit. This first pair may be connected to or provide energy to a second pair of induction coil members. The energy transmission member of the second pair may be part of or a component of an energy transmission unit. The energy transmission unit of the second pair may comprise one or more energy transmission members. The energy receiving member of the second pair may be part of or a component of an energy receiving unit. The energy receiving unit of the second pair may comprise one or more energy receiving members. The energy receiving unit may be part of or a component of an energy using or energy storing device. There may be more than one energy receiving unit comprising the first pair and there may be more than one first pair connected to a single energy transmission unit of the second pair. An energy receiving unit of the first pair may be connected to an energy transmission unit of the second pair or may be connected to more than one energy transmission unit of the second pair. A single energy receiving unit of the first pair may be connected to multiple second pairs. There may be at least one energy receiving member and at least one energy receiving unit comprising at least one first pair. There may be at least one energy transmission member and at least one energy transmission unit comprising at least one second pair. The at least one energy receiving unit of the first pair and the at least one energy transmission unit of the second pair may be connected in series or parallel or combinations thereof. The circuit configuration may include at least one energy storage device and at least one control unit. The at least one energy receiving unit of the first pair and the at least one energy transmission unit of the second pair may be connected in series or parallel or combinations thereof and may be configured to function while in motion and while in motion may occupy a space and location having a pre-established relationship to each another. The circuit configuration may include at least one energy storage device and at least one control unit. Each of various configurations of first pair or pairs and second pair or pairs involve a wireless or contactless transmission between the parts of the first pair and a wireless or contactless transmission between the parts of second pair. Any of these parings may be configured to function while in motion and while in motion may occupy a space and location having a pre-established relationship to each another.

The invention herein will be better understood by reference to the figures, wherein like reference numbers refer to like components.

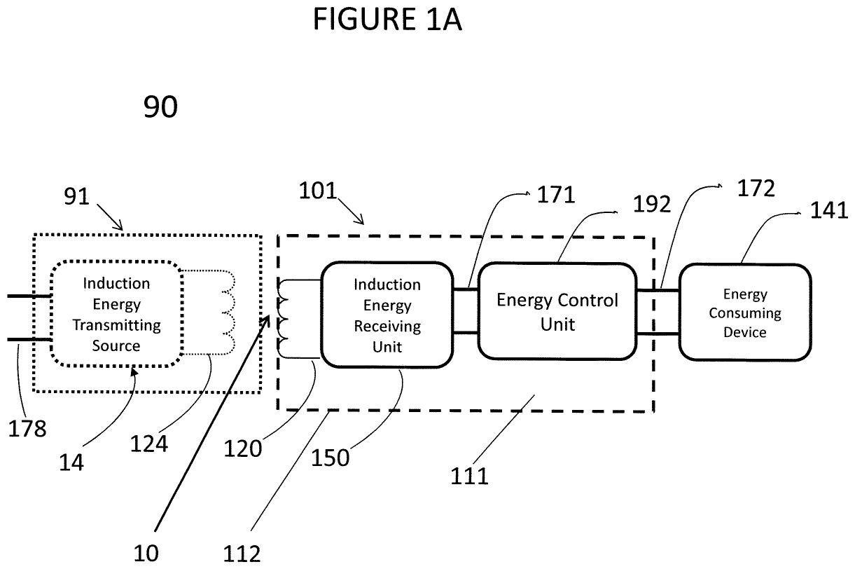

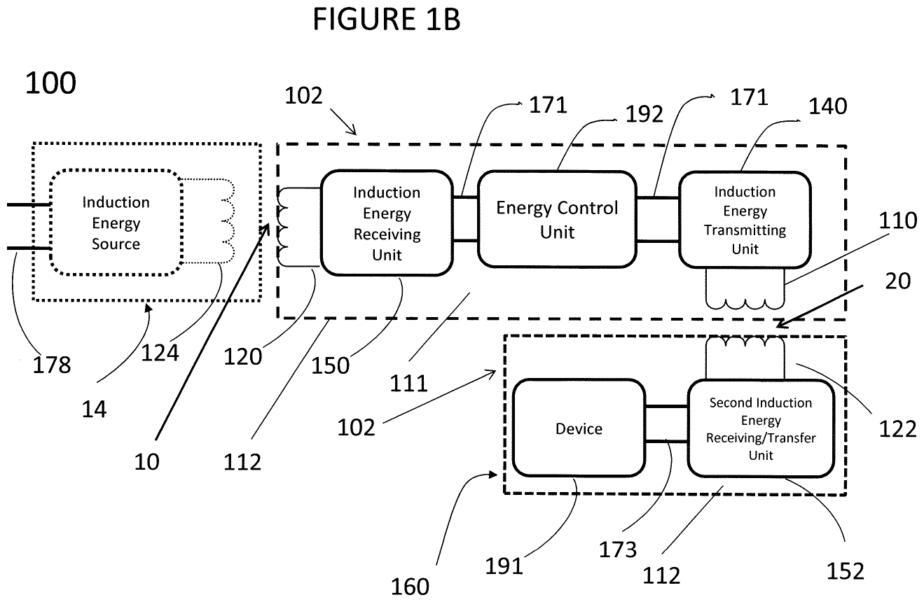

FIG. 1A is an illustration of a wireless induction energy transfer system (90) comprising an energy receiving apparatus (101) of the present invention, which may be at times referred to herein as a “kit”, and an inductive energy source (14). Shown is an energy transfer system (90) comprising an inductive energy source (14), an energy transfer gap (10), a primary induction receiving unit (150), at least one primary electrical conductor (171), and at least one second conductor (172). This particular embodiment of the inductive energy receiving unit has an energy control unit (192) and shows all components of the energy receiving apparatus (101) integrated into and enveloped in a binder resin (111) to comprise an advanced composite structure (112).

The primary induction energy receiving unit (150) comprises at least one energy receiving induction coil member (120). An induction energy source (14) is connected to a suitable power source (not shown) and through a combination of an energy receiving unit (150), at least one interconnecting wire (171), an energy control device (192), and at least one terminal connecting wire (172) to an energy consuming device (141), The at least one terminal wire (172) serves primarily to provide power to the device (141) and secondarily may serve to transfer data between the device (141) and the control unit (192). A suitable connector unit or plug (not shown) may be provided at the point where the one or more secondary wires, also referred to herein as terminal wire(s), (172) exit the energy receiving apparatus (101) and may serve to allow for easy and/or rapid interconnection of the energy receiving apparatus (101) and the device (141).

An energy source gap (10) is shown interspacing the induction energy source (14) and the energy receiving apparatus (101). A configuration of two induction coils (120, 124) is illustrated in a mutually parallel alignment wherein the working surfaces of the coils may occupy a space and location having a pre-established relationship to each another. The relationship may be configured to provide for optimal energy transfer. Further, the relationship may be configured and maintained between the coils (120, 124) while both the energy source apparatus (14) and of the energy receiving apparatus (101) are in motion.

The energy source gap (10) may be configured to at least one of; receive, control, and direct a flow of at least one of; a gas, air, a fluid, a liquid, a stream of fine particles, solid particles suspended in a gas, or combinations thereof.

The energy source gap (10) may be configured to at least one of; receive, control, and direct a flow of at least one of a gas, air, a fluid, a liquid, a stream of fine particles, solid particles suspended in a gas, or combinations thereof while at least one of the energy source apparatus (14) and of the energy receiving apparatus (101) is in motion.

The wireless induction energy transfer system (90) depicted in FIG. 1A may be configured to transfer electric energy in the form of alternating current (AC) ranging from 1 HZ to about 1000 HZ and in the range of 0.01 W to about 500 KW.

FIG. 1B is a further illustration of a wireless induction energy transfer system (100) comprising an energy transfer apparatus (102) of the present invention. The system (100) is comprises three separate apparatus which act cooperatively to deliver electric energy in the form of AC power, wherein said power originates via connecting wires (178) from a feed source (not shown) to the induction energy source (14) and passes through the energy transfer apparatus (102) and then passes through a second inductive energy receiving/transfer unit (152) to an energy powered device (191). The energy transfer apparatus comprises one of at least; a primary induction receiving unit (150), at least one conductor (171), and an induction energy transmission unit (140) referred to as a second induction energy transmitting unit. This particular embodiment has an energy control unit (192) which illustrates all of the components of the energy transfer apparatus (102) integrated into and enveloped in a binder resin (111) to comprise an advanced composite structure (112). This structure may be referred to as a kit.

Referring to FIG. 1B, the primary induction energy receiving unit (150) comprises at least one energy receiving induction coil member (120). An induction energy source (14) and related energy transmitting coil (124) is connected via wires or cables (178) to a suitable power source (not shown) and an induction chargeable and/or power consuming device (191) is shown connected by wires (173) to a second inductive energy receiving unit (152) proximal to the energy transmitting apparatus (140). An energy source gap (10) indicates the contactless or wireless connection between the induction energy source (14) and the energy transfer apparatus (102). A second energy transmitting gap (20) establishes a contactless or wireless connection between the energy transfer apparatus (102) and the induction charge receiving unit (160) comprised of a power utilizing device (191) and a second induction energy receiving unit (152) and interconnecting wire(s) (173). The induction powered device (191) together with the secondary induction energy receiving unit (152) as well as the inductive coil member (122) and interconnects (173) may be embedded in a suitable host resin (112) to comprise an advanced composite inductive charge transfer structure of the present invention. Similarly, this structure may be referred to as an inductive charge receiver kit.

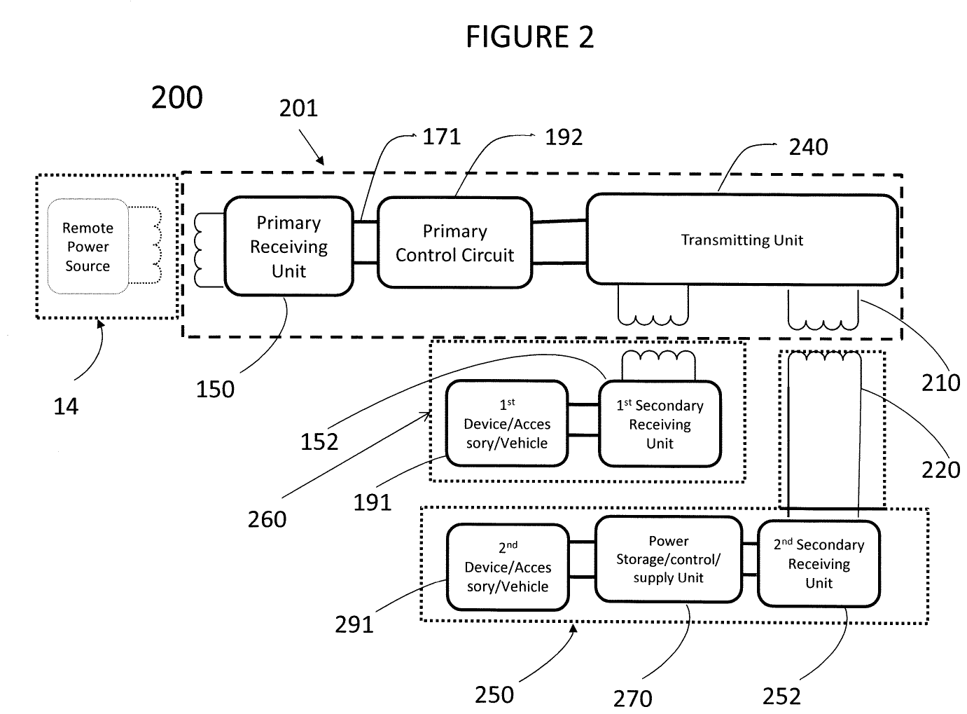

FIG. 2 is a wireless induction energy delivery system (200) capable of providing energy to a plurality of power utilizing devices (191, 291). An energy transfer apparatus (201) is comprised of; a primary induction transmission unit (240) with multiple induction energy transmission coil members (210), at least one conductor (171), and a primary induction receiving unit (150). This embodiment shows an energy control unit (192) which may serve to execute a variety of functions, for example, it may regulate current, regulate voltage, coordinate and tune the phasing of the frequency received from the receiving unit (150) and interconnected with the transmitting unit (240), or combinations thereof. An induction energy source (14) is also depicted. A first secondary induction energy receiving unit (152) capable of receiving inductive energy from transmitting unit (240) and delivering said power to a 1st powered device (191) and a second induction energy receiving unit (252) that is capable of receiving and delivering power to a 2nd powered device (291) are depicted as independent, and optionally as separable, or movable units (250, 260).

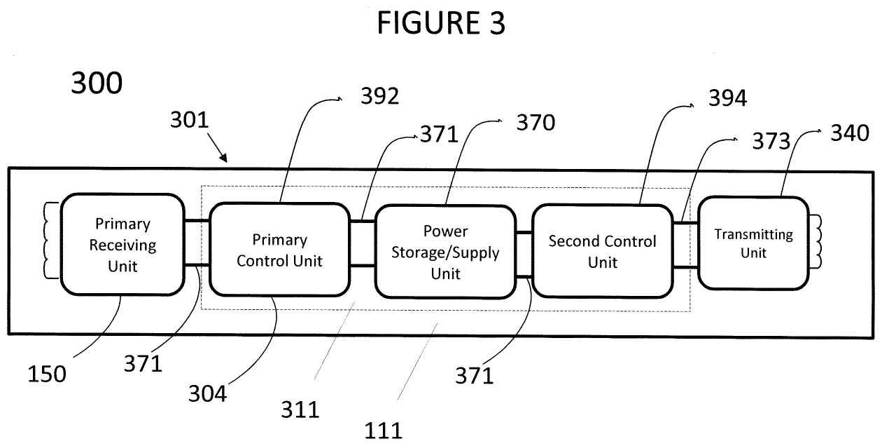

FIG. 3 illustrates a wireless induction energy apparatus (301) of the present invention comprising an integrated power storage and supply unit (370) with a primary power control unit (392) and a second power control unit (394). The energy control units (392, 394) are configured to function cooperatively to execute a variety of functions through a variety of optional interconnecting circuits (not shown). For example, at least one power control unit (392) may regulate current and regulate voltage, while the coordinated interactions of both (392, 394) may serve to coordinate and tune, at least one of the wave form, the phasing of the frequency of the AC energy, or a combination thereof that is received from the receiving unit (150) and thereby deliver energy having an optimized current, voltage, AC wave form, and frequency to the transmitting unit (340), or combinations thereof. A primary induction receiving unit (150) and an induction transmission unit (340) are also shown. The primary power control unit (392) is configured at least to rectify and regulate the incoming AC energy and deliver via wires (371) at a suitable output level of DC energy to the power storage unit (370). The power storage unit (370) may be in the form of a battery, a capacitor, or combinations thereof. The power storage unit (370) delivers power to a second control unit (394) that serves as a DC to AC converter and as a conduit of the converted power via wires (373) to the inductive transmitting unit (340). The inter-device, interconnecting wires also referred to as “cables” (371,373) may be appropriately configured to serve to communicate data and/or signal level energy to and/or from at least one of; the receiving unit (150), the primary control unit (392), the power supply unit (370), the second control unit (394), and the transmitting unit (340).

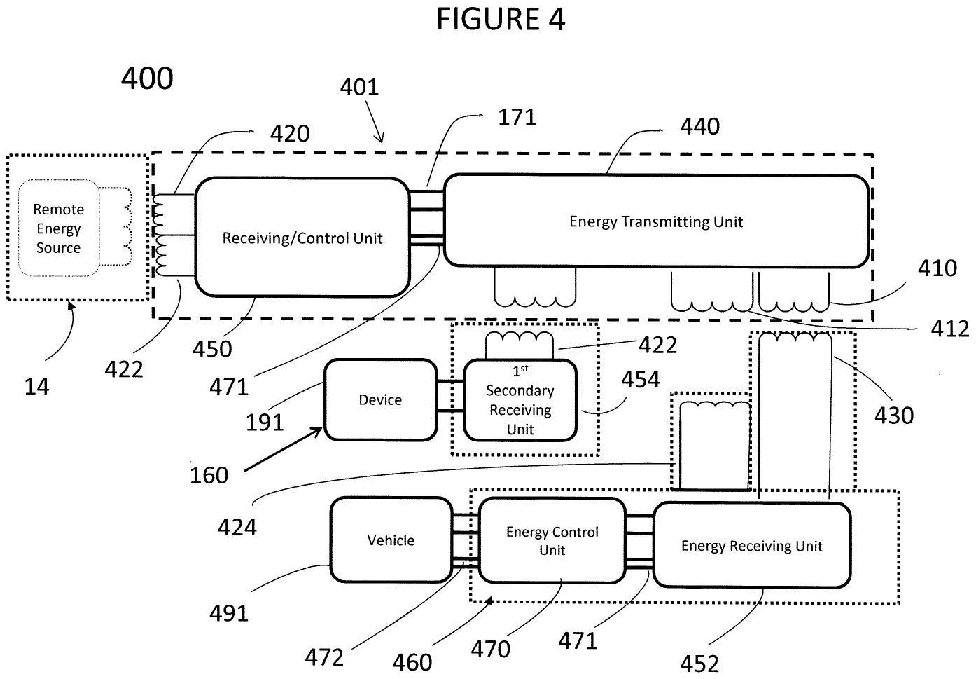

FIG. 4 is an illustration of a wireless induction energy system (400) configured to transfer more than one energy level or type to more than one accessory where the accessories may be positioned at different locations. The wireless induction energy apparatus (401) comprises an induction energy receiving unit (450), having a plurality of energy receiving induction coil members (420, 422). The wireless induction energy apparatus (401) further comprises an induction energy transmission unit (440) comprising a plurality of energy transmission induction coil members (410, 412). The induction energy transmission unit (440) provides for transfer of inductive energy to at least two secondary induction energy receiving unites (452, 454), wherein the plurality of induction energy receiving units (452, 454) receive and transfer said energies to one powered device (160) utilizing one form of energy and to a powered vehicle (491) requiring a second type of energy. Thus, we observe that the wireless induction energy apparatus (401) is capable of providing a variety of energy types and levels of power to multiple power consuming devices (191, 491). Optionally, the entire induction energy system (400) may be placed into motion and therein provide for the dynamic inductive charge transfer system of the present invention.

FIGS. 1, 2, and 4 illustrate various embodiments of a wireless induction energy apparatus that are connected in a series circuit configuration.

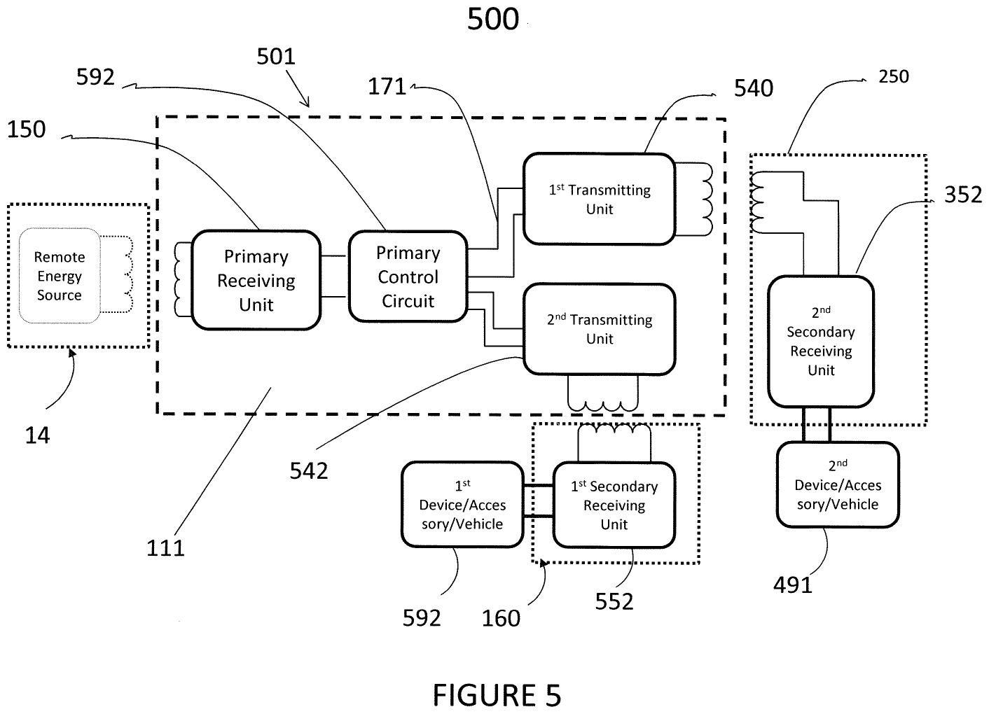

FIG. 5 is an illustration of an exemplary apparatus configured to transfer energy to a plurality of accessories in a parallel arrangement. Energy transfer apparatus (501) comprises a primary induction energy receiving unit (150), and a control unit (592) to which a first primary induction energy transmission unit (540) and a second primary induction energy transmission unit (542) are connected in a parallel circuit configuration. The second secondary induction energy receiving unit (352) is shown in proximity to the first primary induction energy transmission unit (540) and the first secondary induction energy receiving unit (552) is shown in proximity to the second primary induction energy transmission unit (542). FIG. 5 illustrates an optional variation of the apparatus wherein the entire apparatus 501 is enveloped within a polymer-based resin (111) to form a lightweight, weather-resistance kit.

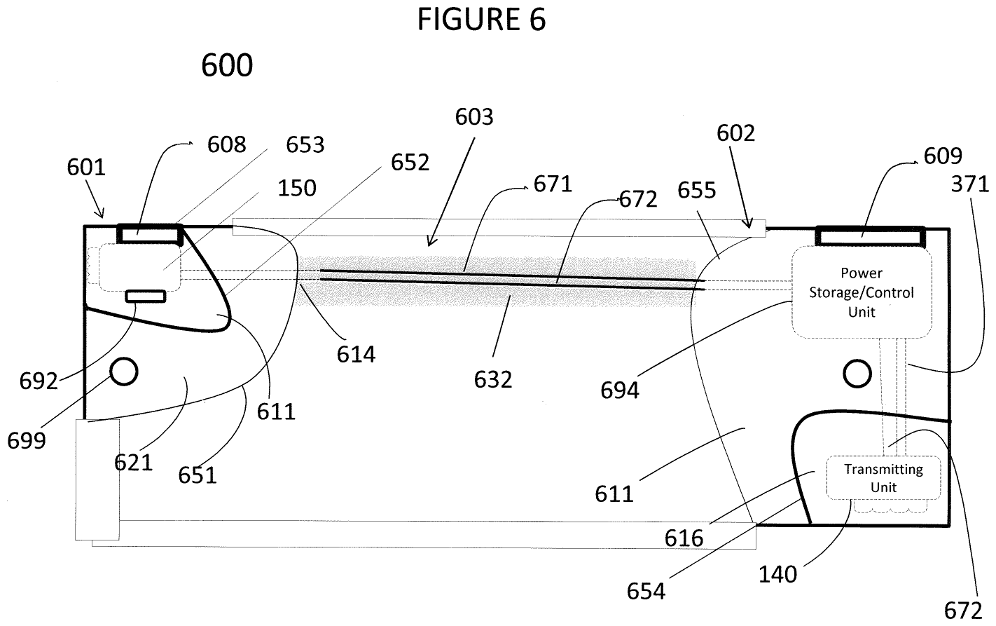

FIG. 6 is an illustration of an exemplary inductive charge transfer apparatus (600) comprising a plurality of advanced composite structures (601, 602, 603) and advanced composite materials (611, 616) that form synergistically interacting regions and sub-regions. The figure illustrates an exemplary inductive charge transfer apparatus (600) that provides for transmission of power as well as for data from one location to a second location. It is suitable for power and data transmission while in motion. The apparatus (600) comprising a multifunctional inductive receiving module (601) also referred to as an advanced composite structure, an integrated multifunctional transmitting module (602) also referred to as a second advanced composite structure and an interconnecting multifunctional cable unit (603). The cable unit (603) serves to establish a power and signal path to interconnect the receiving module (601) and the transmitting module (602). The receiving module (601) comprises at least one of; an induction energy receiving unit (150), a power control unit (608), a signal transceiver unit (692), internal interconnects for power and signal (not labelled), and at least one entry point (614) for an interconnecting cable (603). The transmitting module (602) is shown to include a thermal energy transfer sub-region (653) comprising a suitable thermally conductive composite (608) which serves to provide heat management for at least one of; the receiving unit (150), the transceiver unit (692), the internal circuitry (not shown), or combinations thereof. Illustrated is an optional arrangement of a thermal management region (652) which envelops the entirety of the receiving unit (150), the transceiver unit (692), and the internal circuitry (not shown) within a thermally conductive, electrically insulating composite (611). Either option may be encased by, partially encased by, fully enveloped within, and/or partially enveloped by a suitable polymer-based resin (621) to comprise a general region (651) and thusly forming the multifunctional inductive receiving module (601) of the present invention. This module (601) may be mounted to another apparatus such as onto a moving vehicle, for example, via the mounting accommodation (699) shown in FIG. 6.

Illustrated in FIG. 6 is also a multifunctional transmitting module (602) which is interconnected to the receiving unit (601) via a multifunctional cable (603). The cable (603) may be in the form of a flexible cable, a rigid cable, or have regions that are flexible and other regions that are rigid depending upon the specific requirements of the end application. The cable (603) comprises at least one of; a power conveying wire, a power conveying cable, a data conveying wire, a data conveying cable, a signal level power conveying wire, a data conveying fiber optic, or combinations thereof, which may be configured in an optional wrapping (632) to form a multifunctional cable (603).

Referring to FIG. 6, within the transmitting module (602) is shown a power storage and control unit (694), an inductive power transmitting unit (140), internal power wires (371) and internal data transmission wires or cabling (672). The power storage and control unit (694) may be integrated as part of a thermal management sub-region (609), a second thermal management sub-region (654) may encase all, or part, of the transmitting unit (140). The power storage and control unit (694), the thermal management sub-region (609), the transmitting unit (140) the second thermal management sub-region (654), and the internal wires and cables (371,672) may be enveloped, fully or partially, within a polymer-based resin (611) to form a multifunctional, integrated advanced composite structure of the present invention.

Thusly illustrated in FIG. 6 is a charge transfer apparatus (600) that may be referred to as a charge transfer kit wherein the kit may be portable and optionally mounted on a vehicle capable of motion.

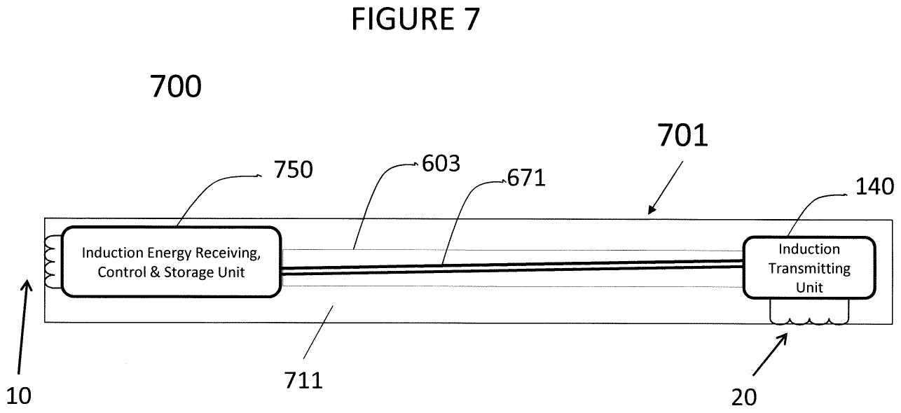

FIG. 7 illustrates a less-featured charge transfer apparatus (700) comprising a polymer-based resin (711) an integrated, multifunctional, induction energy receiving, control, and storage unit (750), an induction transmitting unit (140), a cable assembly (603) comprised of a plurality of interconnecting wires or cables (671) that function cooperatively to wirelessly transfer inductive energy that originates from a non-contacted power source across a first gap (10) to a point of power usage across a second gap (20).

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment. Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. An energy transfer apparatus comprising:
at least one induction energy transmitting source,
at least one energy control unit, and
at least one electrical conductor;
wherein at least one of the at least one induction transmitting source, the at least one electrical conductor, and the at least one energy control unit comprise an integrated system that is operational while in a stationary state and while in motion.

2. The energy transfer apparatus of claim 1, wherein the at least one induction energy transmitting source is connected to an energy supply device that is operational while in a stationary state and while in motion.

3. The energy transfer apparatus of claim 2, wherein the energy supply device is a motion-capable, person portable, vehicle integrated, or vehicle portable energy supply, for example a solar, gas, diesel, hydrogen, or other powered generator that is operational while in a stationary state and while in motion.

4. The energy transfer apparatus of claim 1, wherein the apparatus is affixed to or secured upon or within a vehicle or any platform that is capable of movement.

5. The energy transfer apparatus of claim 1, wherein the apparatus is affixed to or secured upon or within a vehicle or any platform that is capable of motion and is connected to a power source that is affixed to or secured upon or within a vehicle or any platform that is also capable of motion.

6. The energy transfer apparatus of claim 1, wherein the apparatus is affixed to or secured upon an outer, an upper outer or inner surface of a vehicle or any platform that is capable of movement.

7. The energy transfer apparatus of claim 6, wherein the vehicle and the apparatus are in motion.

8. The energy transfer apparatus of claim 6, wherein the apparatus is operationally functional while in motion.

9. The energy transfer apparatus of claim 1, wherein at least a portion of the apparatus is enveloped within a polymer-based resin to comprise an advanced composite structure.

10. The advanced composite structure of claim 9, wherein the components of the advanced composite structure are arranged to form an advanced composite inductive energy transmitter kit.

11. The inductive energy transmitter kit of claim 10 wherein the kit is weather-resistant.

12. The energy transfer apparatus of claim 1 configured to transmit various forms and levels of; AC power, AC power having a predesigned, non-sinusoidal shaped wave form, DC power, pulsed DC power, pulsed DC power with a predesigned waveform, or combinations thereof within the frequency range of 1 to about 1 KHz and in the power range of 1 amp to about 200 amps at voltage levels in the range of 6 to about 1 kilovolt.

13. The advanced composite inductive energy transmitter kit of claim 10 configured to transmit various forms and levels of AC power, including high levels of AC power having a predesigned, non-sinusoidal shaped wave form, DC power, pulsed DC power, pulsed DC power with a predesigned waveform, or combinations thereof within the frequency range of 1 to about 1 KHz and in the power range of 1 amp to about 200 amps at voltage levels in the range of 6 to about 1 kilovolt.

14. An energy transfer apparatus comprising:
at least one induction energy receiving unit;
at least one energy control unit, and
at least one electrical conductor;
wherein at least one of the at least one induction receiving unit, the at least one electrical conductor, and the at least one energy control unit comprise an integrated system that is operational while in a stationary state and while in motion.

15. The energy transfer apparatus of claim 14, wherein the at least one induction energy receiving unit is connected to at least one energy control unit, to at least energy supply unit, and to at least one energy transmitting apparatus to comprise an energy transfer system that is operational while in a stationary state and while in motion.

16. The energy transfer apparatus of claim 14, wherein the energy receiving unit is connected to the at least one transmitting unit and is operational while in a stationary state and while in motion.

17. The energy transfer apparatus of claim 14, wherein the apparatus is affixed to or secured upon or within a vehicle or any platform that is capable of movement.

18. The energy transfer apparatus of claim 14, wherein the apparatus is affixed to or secured upon or within a first vehicle or any platform that is capable of motion and is connected to a power source that is affixed to or secured upon or within a second vehicle or any platform that is also capable of motion.

19. The energy transfer apparatus of claim 14, wherein the apparatus is affixed to or secured upon an outer, an upper outer or inner surface of a vehicle or any platform that is capable of movement.

20. The energy transfer apparatus of claim 16, wherein the vehicle and the apparatus are in motion.
